(19) United States
(12) Patent Application Publication
(10) Pub. No.: US 2013/0257714 A1
(43) Pub. Date: Oct. 3, 2013

(54) ELECTRONIC DEVICE AND DISPLAY CONTROL METHOD

(71) Applicant: Takahiro Suzuki, Hamura-shi (JP)

(72) Inventor: Takahiro Suzuki, Hamura-shi (JP)

(21) Appl. No.: 13/692,495

(22) Filed: Dec. 3, 2012

(30) Foreign Application Priority Data
Mar. 30, 2012 (JP) 2012-081538

(51) Int. Cl. G06F 3/01

(52) U.S. Cl. CPC G06F 3/016
USPC 345/156

(57) ABSTRACT

According to one embodiment, an electronic device includes: a housing; a display device in the housing, the display device comprising a screen; an imaging module in the housing, the imaging module being configured to take an image in front of the screen; an acceleration sensor in the housing; and a display controller configured to control the display device to display an image based on first image data on the screen, and configured to change the image displayed on the screen based on a change with time in second image data taken by the imaging module and a change with time in acceleration data obtained by the acceleration sensor to suppress, when the housing moves relative to at least one viewpoint in front of the screen, a change in appearance of the image displayed on the screen as viewed from the viewpoint.

### CROSS-REFERENCE TO RELATED APPLICATIONS

This application is based upon and claims the benefit of priority from Japanese Patent Application No. 2012-081538, filed Mar. 30, 2012, the entire contents of which are incorporated herein by reference.

### FIELD

Embodiments described herein relate generally to an electronic device and a display control method.

### BACKGROUND

There is disclosed a portable terminal device that keeps a visual display size and a visual display position of a display image constant by correcting a display position and a display magnification of the display image displayed on a display, based on amounts of movement in the up-down, right-left, and fore-aft directions of the portable terminal device obtained by an acceleration sensor and on image data obtained by a camera.

In conventional techniques, the display magnification of the display image displayed on the display is corrected by using an autofocus function in which a distance to a user is measured based on the image data obtained by the camera. Therefore, if the user moves during a period from when the image data is obtained by the camera until the display image is displayed on the display, the visual display size and the visual display position of the display image cannot be kept constant.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram schematically illustrating an external appearance on the front side of an electronic device according to a first embodiment;

FIG. 2 is an exemplary block diagram illustrating an example of a hardware configuration of the electronic device in the first embodiment;

FIG. 3 is an exemplary block diagram illustrating a functional configuration of the electronic device in the first embodiment;

FIG. 4 is an exemplary flow chart illustrating a flow of a display control process of first image data in the electronic device in the first embodiment;

FIG. 5 is an exemplary diagram for explaining a process of obtaining a delay time in the electronic device in the first embodiment;

FIG. 6 is an exemplary diagram for explaining a process of estimating changes with time in positions of feature points in a second time period in the electronic device in the first embodiment;

FIG. 7 is an exemplary diagram for explaining a process of determining a display position of the first image data on a screen in the electronic device in the first embodiment;

FIG. 8 is an exemplary diagram for explaining a process of determining the display position of the first image data on the screen in the electronic device in the first embodiment;

FIG. 9 is an exemplary diagram for explaining a process of determining the display position of the first image data on the screen in the electronic device in the first embodiment;

FIG. 10 is an exemplary diagram schematically illustrating an external appearance on the back side of an electronic device according to a second embodiment;

FIG. 11 is an exemplary block diagram illustrating an example of a hardware configuration of the electronic device in the second embodiment; and

FIG. 12 is an exemplary block diagram illustrating a functional configuration of the electronic device in the second embodiment.

### DETAILED DESCRIPTION

In general, according to one embodiment, an electronic device comprises: a housing; a display device in the housing, the display device comprising a screen; an imaging module in the housing, the imaging module being configured to take an image in front of the screen; an acceleration sensor in the housing; and a display controller configured to control the display device to display an image based on first image data on the screen, and configured to change the image displayed on the screen based on a change with time in second image data taken by the imaging module and a change with time in acceleration data obtained by the acceleration sensor to suppress, when the housing moves relative to at least one viewpoint in front of the screen, a change in appearance of the image displayed on the screen as viewed from the viewpoint.

Details of an electronic device and a display control method according to embodiments will be described below with reference to the accompanying drawings. In the embodiments below, the description will be made of an example of an electronic device, such as a personal digital assistant (PDA) or a cellular phone, used while being held by a user.

### First Embodiment

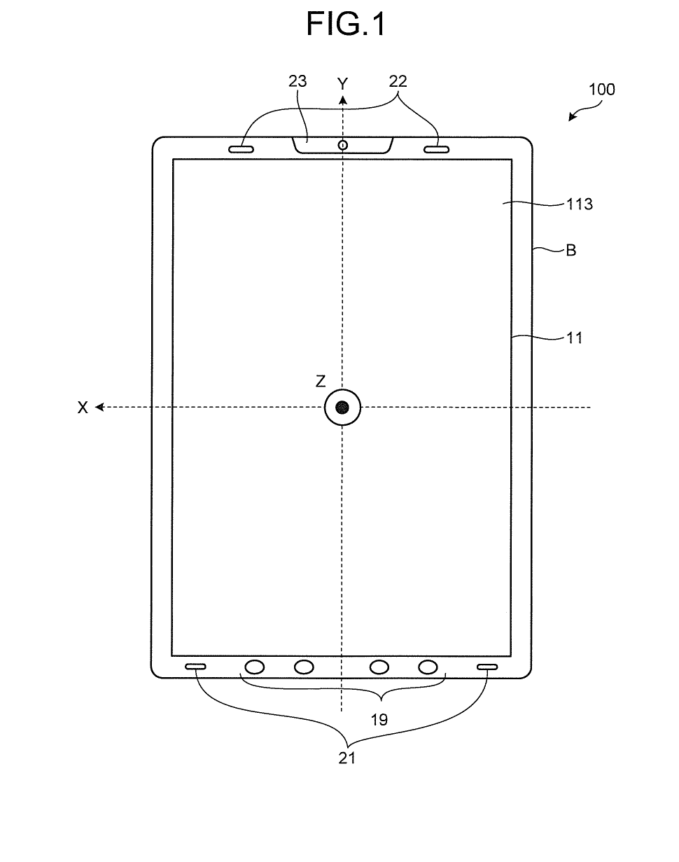

FIG. 1 is a diagram schematically illustrating an external appearance on the front side of an electronic device according to a first embodiment. An electronic device 100 is an information processing device comprising a screen, and is implemented as, for example, a slate computer (tablet computer), an e-book reader, and a digital photo frame. Note that, here, the direction of an arrow of each of the X-axis, the Y-axis, and the Z-axis (front direction of FIG. 1 for the Z-axis) is defined as the positive direction (hereinafter the same applies).

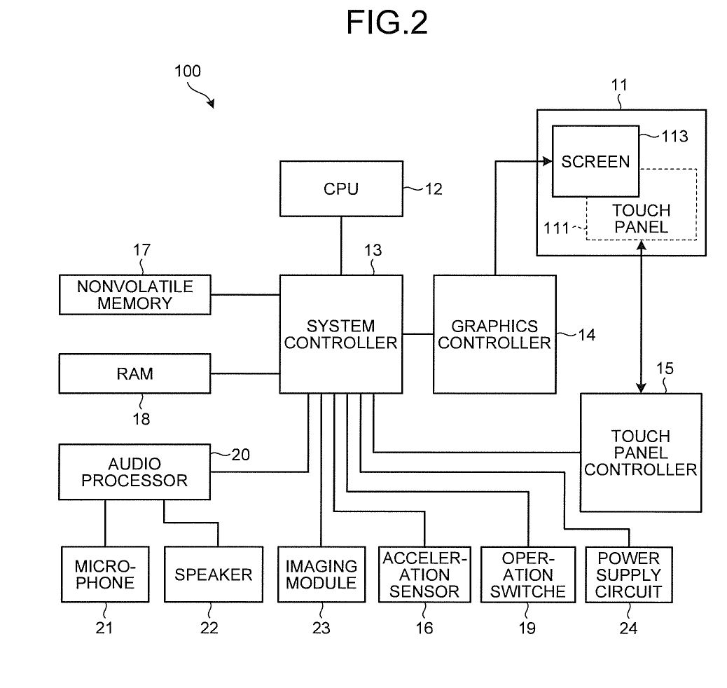

The electronic device 100 comprises a thin box-like housing B. The housing B is provided, on the front face thereof, with a display module 11 comprising a screen 113. In the present embodiment, the display module 11 displays images based on various types of image data (hereinafter referred to as first image data), such as image data of an electronic book when the electronic device 100 is used as an e-book reader. In the present embodiment, the display module 11 comprises a touch panel 111 (refer to FIG. 2) that detects a position touched by the user on the screen 113. In the present embodiment, a description will be made of an example in which the electronic device 100 is operated through the touch panel 111, operation switch 19 (to be described later), or the like. However, the electronic device 100 may be operable with a device that allows various types of information to be entered by moving a hand in front (in the vicinity) of the screen 113, or with buttons, a pointing device, and the like. An upper front portion of the housing B is provided with an imaging module 23 directed toward the front of the screen 113. The imaging module 23 takes an image in front of the screen 113. Then, the imaging module 23 outputs the image data taken (hereinafter referred to as second image data) to a system controller 13 (refer to FIG. 2). A lower front portion of the housing B is arranged with the operation switch 19 serving as operation switch, and the like, with which the user performs various operations, and arranged with microphone 21 for acquiring a voice of the user. The upper front portion of the housing B is arranged with speaker 22 for producing an audio output.

FIG. 2 is a block diagram illustrating an example of a hardware configuration of the electronic device according to the first embodiment. As illustrated in FIG. 2, the electronic device 100 according to the first embodiment comprises, in addition to the above-described configuration, a central processing unit (CPU) 12, the system controller 13, a graphics controller 14, a touch panel controller 15, an acceleration sensor 16, a nonvolatile memory 17, a random access memory (RAM) 18, an audio processor 20, a power supply circuit 24, and the like.

In the present embodiment, the display module 11 comprises the touch panel 111 and the screen (display) 113 such as a liquid crystal display (LCD) or an organic electro-luminescence (EL) display. The touch panel 111 comprises, for example, a coordinate detecting device of a touch surface arranged on the screen 113. Thus, the touch panel 111 can detect a position (touch position) on the screen 113 touched by, for example, a finger of the user holding the housing B. By work of the touch panel 111, the screen 113 functions as a so-called touchscreen.

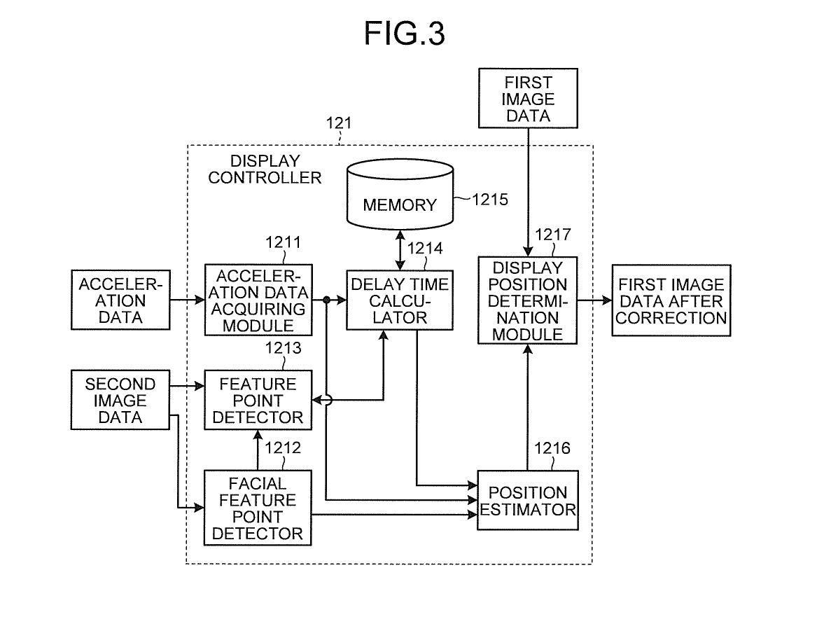

The CPU 12 is a processor that performs central control of operations of the electronic device 100, and controls various modules of the electronic device 100 through the system controller 13. The CPU 12 executes an operating system loaded from the nonvolatile memory 17 into the RAM 18, and thereby implements functional modules (refer to FIG. 3) to be described later. The RAM 18, serving as a main memory of the electronic device 100, provides a work area used when the CPU 12 executes a program.

The system controller 13 also incorporates therein a memory controller that performs access control of the nonvolatile memory 17 and the RAM 18. The system controller 13 also comprises a function to perform communication with the graphics controller 14. The system controller 13 further incorporates therein a microcomputer integrated with an embedded controller controlling the power supply circuit 24 that supplies power stored in a battery (not illustrated) provided in the electronic device 100, and with a controller (keyboard controller) controlling the operation switch 19, and the like.

The graphics controller 14 is a display controller that controls display of images onto the screen 113 used as a display monitor of the electronic device 100. The touch panel controller 15 controls the touch panel 111, and obtains, from the touch panel 111, coordinate data indicating the touch position touched by the user on the screen 113.

The acceleration sensor 16 is provided in the housing B, and is, as an example, an acceleration sensor of three-axis directions (X, Y, and Z directions) illustrated in FIG. 1, or that of six-axis directions that has a detection function in, in addition to the three-axis directions, rotational directions about the respective axes. The acceleration sensor 16 detects orientations and amounts of acceleration of the housing B (electronic device 100), and outputs acceleration data including the orientations and the amounts of acceleration detected to the CPU 12. Specifically, the acceleration sensor 16 outputs, to the CPU 12, acceleration data including axes on which the acceleration is detected, orientations (rotational angles in the case of rotation), and amounts. The acceleration sensor 16 may take a form of being integrated with a gyro sensor for detecting angular velocities (rotational angles).

The audio processor 20 applies audio processing, such as digital conversion, noise removal, and echo cancellation, to a voice signal received from the microphone 21, and outputs the processed signal to the CPU 12. The audio processor 20 also outputs, under the control of the CPU 12, to the speaker 22 a voice signal generated by applying audio processing such as speech synthesis, and thus gives a voice announcement with the speaker 22.

FIG. 3 is a block diagram illustrating a functional configuration of the electronic device according to the first embodiment. As illustrated in FIG. 3, the electronic device 100 according to the first embodiment comprises a display controller 121 as a functional module in cooperation with the CPU 12, the system controller 13, the graphics controller 14, and the software (operating system).

The display controller 121 controls the display module 11 so as to display an image based on the first image data on the screen 113 of the display module 11. In addition, when the housing B moves relative to at least one viewpoint in front of the screen 113, the display controller 121 changes the image displayed on the screen 113 so as to suppress a change in appearance of the image displayed on the screen 113 (how the image looks) as viewed from the viewpoint, based on changes with time in the second image data taken by the imaging module 23 and on a change with time in the acceleration data obtained by the acceleration sensor 16. In other words, the display controller 121 changes the image displayed on the screen 113 so that the same image is displayed on a plane that is perpendicular to a direction of line of sight from the at least one viewpoint in front of the screen 113 and that is located at a preset distance from the viewpoint.

In the present embodiment, when the housing B moves relative to the at least one viewpoint in front of the screen 113, the display controller 121 changes the image displayed on the screen 113 so as to suppress the change in appearance of the image displayed on the screen 113 as viewed from the viewpoint, based on the changes with time in the second image data including image data of a face taken by the imaging module 23 and on the change with time in the acceleration data obtained by the acceleration sensor 16. Specifically, the display controller 121 comprises an acceleration data acquiring module 1211, a facial feature point detector 1212, a feature point detector 1213, a delay time calculator 1214, a memory 1215, a position estimator 1216, and a display position determination module 1217.

In the present embodiment, the display controller 121 changes the image displayed on the screen 113 based on the changes with time in the second image data including the image data of a face taken by the imaging module 23 and on the change with time in the acceleration data obtained by the acceleration sensor 16. However, the display controller is not limited to this. For example, when the housing B moves relative to the at least one viewpoint in front of the screen 113, the display controller 121 may change the image displayed on the screen 113 so as to suppress the change in appearance of the image displayed on the screen 113 as viewed from the viewpoint, based on the changes with time in the second image data including image data corresponding to third image data (for example, image data of information to identify a face, such as eyeglasses worn on the face existing in front of the screen 113) stored in advance and on the change with time in the acceleration data obtained by the acceleration sensor 16.

In the present embodiment, the display controller 121 detects, through the power supply circuit 24, a remaining amount of electrical energy stored in the battery (not illustrated) provided in the electronic device 100, and if the detected remaining amount is smaller than a predetermined amount of electrical energy, does not change the image displayed on the screen 113 based on the changes with time in the second image data taken by the imaging module 23 and on the change with time in the acceleration data obtained by the acceleration sensor 16. Thereby, it is possible to reduce power consumption due to processing of changing the image displayed on the screen 113.

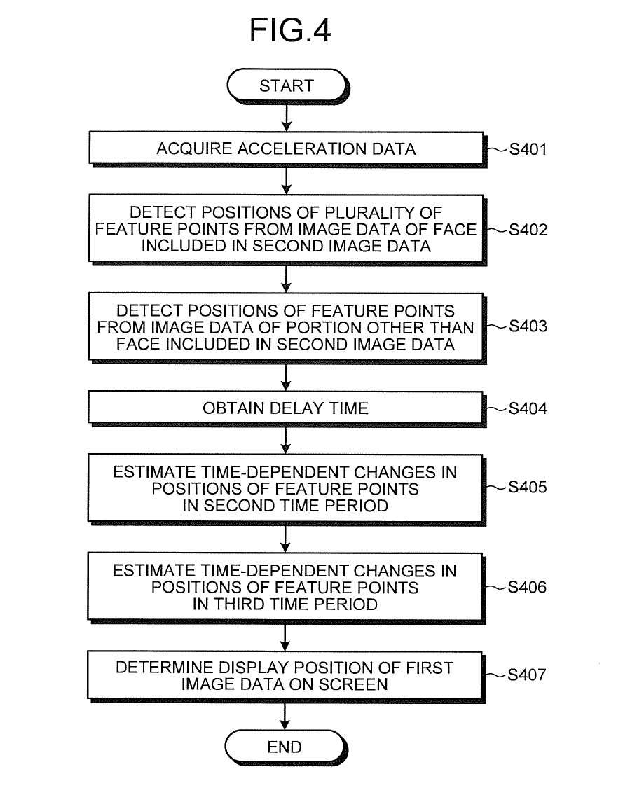

FIG. 4 is a flow chart illustrating a flow of a display control process of the first image data in the electronic device according to the first embodiment. After the touch panel 111 is touched, and thus the first image is requested to be displayed, the acceleration data acquiring module 1211 acquires the acceleration data obtained by the acceleration sensor 16 (S401). In the present embodiment, the acceleration data acquiring module 1211 acquires the acceleration data by detecting the acceleration at a preset sampling rate with the acceleration sensor 16.

In addition, the facial feature point detector 1212 detects positions of a plurality of feature points from the image data of a face included in the second image data taken by the imaging module 23 (S402). In the present embodiment, the facial feature point detector 1212 detects the positions of a plurality of (such as three) feature points from the image data of a face included in the second image data taken by the imaging module 23. Specifically, the facial feature point detector 1212 uses a scale-invariant feature transform (SIFT) algorithm, a speeded up robust features (SURF) algorithm, or the like to distinguish between the image data of a face and the image data of a portion other than the face in the second image data taken by the imaging module 23. Thereafter, the facial feature point detector 1212 detects the positions of a plurality of (such as three) feature points from the image data distinguished as image data of a face among the second image data, by using, for example, a simultaneous localization and mapping (SLAM) technique (an example of parallel tracking and mapping [PTAM]) that uses, for example, a tracking technique, such as the Kanade-Lucas-Tomasi (KLT) technique, of tracking the feature points. In that case, among the feature points of the image data of the face included in the second image data taken by the imaging module 23, the facial feature point detector 1212 detects positions of the same feature points as the feature points of the image data of the face included in the second image data that has been taken prior to the second image data taken by the imaging module 23. That is, among the feature points of the image data of the face included in the second image data taken by the imaging module 23, the facial feature point detector 1212 detects the positions of feature points included in a successive manner from the image data of the face included in the second image data that has been taken prior to the second image data taken by the imaging module 23.

In the present embodiment, the facial feature point detector 1212 detects the positions of a plurality of feature points from the image data of a face included in the second image data taken by the imaging module 23. However, the facial feature point detector is not limited to this as far as positions of a plurality of feature points are detected from the second image data taken by the imaging module 23. For example, the facial feature point detector 1212 may detect positions of a plurality of feature points from image data corresponding to the third image data (for example, image data of information to identify a face) stored in advance, among image data included in the second image data taken by the imaging module 23.

Furthermore, the feature point detector 1213 detects positions of feature points from the image data of the portion other than the face included in the second image data taken by the imaging module 23 (S403). In the present embodiment, the feature point detector 1213 detects positions of a plurality of (such as three) feature points from the image data of the portion other than the face (such as image data of a background) included in the second image data taken by the imaging module 23. Specifically, the feature point detector 1213 uses the SIFT algorithm, the SURF algorithm, or the like to distinguish between the image data of a face and the image data of the portion other than the face in the second image data taken by the imaging module 23. Thereafter, the feature point detector 1213 detects the positions of feature points from the image data distinguished as image data of a portion other than the face among the second image data, by using, for example, the SLAM technique (an example of the PTAM) that uses, for example, a tracking technique, such as the KLT technique, of tracking the feature points. In that case, the feature point detector 1213 detects positions of the same feature points as the feature points of the image data of the portion other than the face included in the second image data that has been taken prior to the second image data taken by the imaging module 23. That is, among the feature points of the image data of the portion other than the face included in the second image data taken by the imaging module 23, the feature point detector 1213 detects the positions of feature points included in a successive manner from the image data of the portion other than the face included in the second image data that has been taken prior to the second image data taken by the imaging module 23.

In the present embodiment, the feature point detector 1213 detects the positions of a plurality of feature points from the image data of the portion other than the face by detecting, among the feature points included in the second image data, the positions of feature points other than the positions of a plurality of feature points detected by the facial feature point detector 1212.

The delay time calculator 1214 obtains a delay time of the second image data relative to the acceleration data from the changes with time in the positions of a plurality of feature points detected by the feature point detector 1213 and the change with time in the acceleration data obtained by the acceleration data acquiring module 1211 (S404). In the present embodiment, the delay time of the second image data relative to the acceleration data is obtained by using the changes with time in the positions of feature points detected from the image data of the portion other than the face included in the second image data. However, the delay time calculator is not limited to this as far as the changes with time in the positions of feature points of the second image data is used.

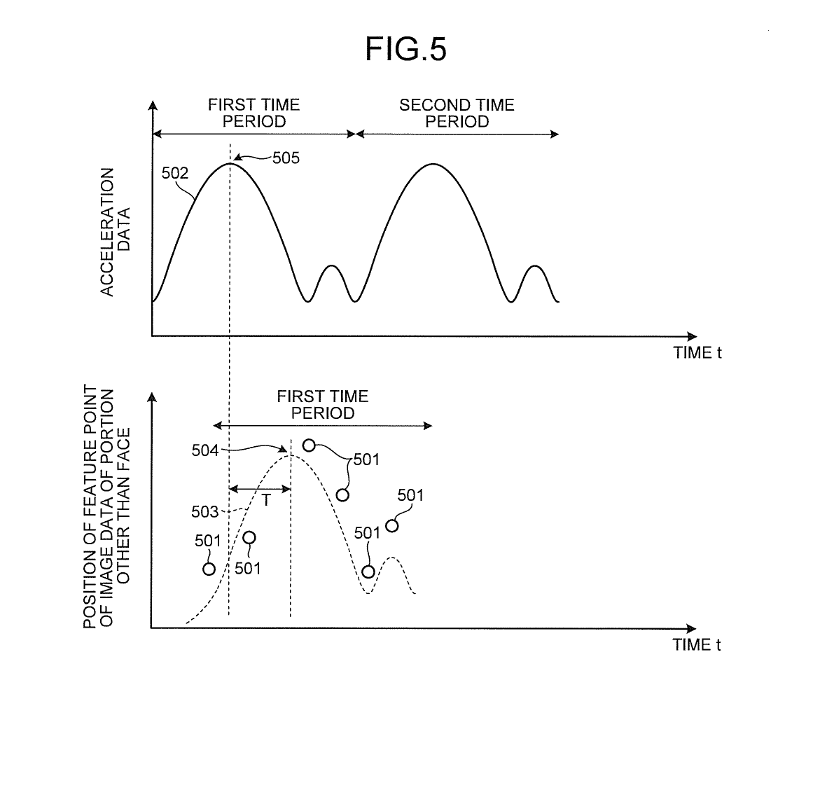

Here, a process of obtaining the delay time will be described using FIG. 5. FIG. 5 is a diagram for explaining the process of obtaining the delay time in the electronic device according to the first embodiment. In the present embodiment, the delay time calculator 1214 makes the memory 1215 store, among the positions of feature points detected by the feature point detector 1213, the positions of feature points detected from the second image data taken within a predetermined period of time (hereinafter referred to as first time period) from when the second image data is last taken by the imaging module 23. The delay time calculator 1214 also makes the memory 1215 store, among the acceleration data obtained by the acceleration data acquiring module 1211, the acceleration data obtained in the first time period and the acceleration data obtained in a period of time after the first time period (hereinafter referred to as second time period).

First, at preset time intervals, the delay time calculator 1214 reads out, among the positions of feature points stored in the memory 1215, the positions of feature points detected from the second image data taken in the first time period. Thereafter, as illustrated in FIG. 5, the delay time calculator 1214 arranges the positions of feature points detected from the second image data taken in the first time period along the time points at each of which the second image data, from which the positions of feature points are detected, has been taken, and obtains changes with time 501 in the positions of feature points detected from the second image data. Furthermore, at preset time intervals, the delay time calculator 1214 reads out, among the acceleration data stored in the memory 1215, the acceleration data obtained in the first time period. Thereafter, as illustrated in FIG. 5, the delay time calculator 1214 arranges the acceleration data obtained in the first time period along the time points at each of which the acceleration data has been obtained in the first time period, and obtains a change with time 502 in the acceleration data.

Thereafter, as illustrated in FIG. 5, the delay time calculator 1214, as an example, shifts the change with time 502 in the acceleration data in the first time period mainly in the direction of time, and fits the change with time 502 to the changes with time 501 in the positions of feature points detected from the second image data taken in the first time period. Thus, the delay time calculator 1214 obtains a curve 503 approximated to (as an example, having the smallest total of errors at respective time points relative to) the changes with time 501 in the positions of feature points detected from the second image data taken in the first time period. Then, the delay time calculator 1214 obtains, as a delay time T, a time period between time at a peak 504 of the obtained curve 503 and time at a peak 505 of the change with time 502 in the acceleration data in the first time period.

In the present embodiment, the delay time T is obtained by fitting the change with time 502 in the acceleration data in the first time period to the changes with time 501 in the positions of feature points included in the second image data taken in the first time period. However, the delay time calculator is not limited to this. For example, the delay time calculator 1214 applies a fast Fourier transform (FFT) to an average of the positions of a plurality of feature points included in the second image data taken in the first time period, and thus obtains frequency components and phases corresponding to the changes with time in the positions of feature points included in the second image data. Further, the delay time calculator 1214 applies the fast Fourier transform to the acceleration data obtained in the first time period to obtain frequency components and phases corresponding to the motion of the electronic device 100. Then, the delay time calculator 1214 may obtain, as the delay time T, a phase difference between the phase of the frequency component obtained by applying the fast Fourier transform to the average of the positions of a plurality of feature points and the phase of the frequency component obtained by applying the fast Fourier transform to the acceleration data. According to the method of obtaining the delay time T by using the frequency components obtained by applying the fast Fourier transform to the average of the positions of feature points included in the second image data and using the frequency components obtained by applying the fast Fourier transform to the acceleration data, the delay time T can be obtained with high accuracy when the electronic device 100 is vibrating in a steady manner.

In addition, the delay time calculator 1214 obtains acceleration by differentiating twice the average of the positions of feature points (for example, feature points of image data of the portion other than the face) included in the second image data taken in the first time period. Then, the delay time calculator 1214 identifies the acceleration data obtained in the first time period corresponding to the acceleration obtained by differentiating twice the average of the positions of feature points included in the second image data taken in the first time period. Then, the delay time calculator 1214 calculates a time period between the time when the identified acceleration data has been obtained and the time when the second image data, from which the positions of feature points are detected and differentiated twice, has been taken. The delay time calculator 1214 may further perform the processing of calculating the time period for each piece of the second image data taken in the first time period, and thus may calculate, as the delay time T, an average of the time periods calculated for the respective pieces of the second image data. According to the method of obtaining the delay time T by using the acceleration obtained by differentiating twice the average of the positions of feature points included in the second image data taken in the first time period and using the acceleration data obtained in the first time period, the delay time T can be obtained with high accuracy when the electronic device 100 is vibrating in an unsteady manner.

If the acceleration data obtained by the acceleration sensor 16 includes the angular velocities obtained by the gyro sensor in the case in which the electronic device 100 rotates, the delay time calculator 1214 obtains a velocity by differentiating once the average of the positions of feature points included in the second image data taken in the first time period. Then, the delay time calculator 1214 identifies the acceleration data (angular velocity) obtained in the first time period corresponding to the velocity obtained by differentiating once the average of the positions of feature points included in the second image data taken in the first time period. Then, the delay time calculator 1214 calculates a time period between the time when the identified acceleration data has been obtained and the time when the second image data, from which the positions of feature points are detected and differentiated once, has been taken. The delay time calculator 1214 further performs the processing of calculating the time period for each piece of the second image data taken in the first time period, and thus calculates, as the delay time T, an average of the time periods calculated for the respective pieces of the second image data.

Referring back to FIG. 4, the position estimator 1216 estimates, from the change with time in the acceleration data and the changes with time in the feature points in the first time period, changes with time in the positions of feature points in the second time period according to a change with time in the acceleration data obtained in the second time period (S405). In the present embodiment, the position estimator 1216 estimates the changes with time in the positions of feature points in the second time period according to the change with time in the acceleration data obtained in the second time period, based on the delay time calculated by the delay time calculator 1214.

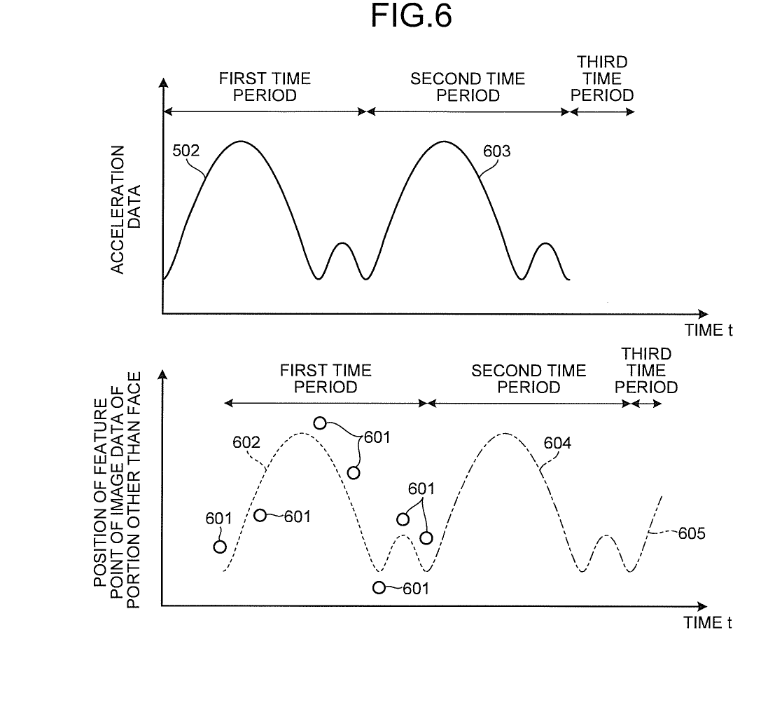

Here, a process of estimating the changes with time in the positions of feature points in the second time period will be described using FIG. 6. FIG. 6 is a diagram for explaining the process of estimating the changes with time in the positions of feature points in the second time period in the electronic device according to the first embodiment.

First, the position estimator 1216 obtains, from the acceleration data acquiring module 1211, the acceleration data obtained by the acceleration sensor 16 in the first time period. Thereafter, as illustrated in FIG. 6, the position estimator 1216 arranges the acceleration data in the first time period along the time points at each of which the acceleration data has been obtained by the acceleration sensor 16 in the first time period, and obtains the change with time 502 in the acceleration data. Further, the position estimator 1216 obtains the positions of feature points detected by the facial feature point detector 1212 from the second image data taken in the first time period. Thereafter, as illustrated in FIG. 6, the position estimator 1216 arranges the positions of feature points detected by the facial feature point detector 1212 from the second image data taken in the first time period along the time points at each of which the second image data, from which the positions of feature points are detected, has been taken, and obtains changes with time 601 in the positions of feature points detected from the second image data.

Thereafter, the position estimator 1216 delays the change with time 502 in the acceleration data in the first time period by the delay time T calculated by the delay time calculator 1214. Then, as illustrated in FIG. 6, the position estimator 1216 changes an amplitude and a gap amount (to be described below) of the change with time 502 in the acceleration data in the first time period delayed by the delay time T, and compares (fits) the change with time 502 with the changes with time 601 in the positions of feature points detected from the second image data taken in the first time period. Thus, the position estimator 1216 obtains a curve 602 approximated to (as an example, having the smallest total of errors at respective time points relative to) the changes with time 601 in the positions of feature points detected from the second image data taken in the first time period. Here, the gap amount is a difference between a reference value of the acceleration data (0 m/s²) and a reference value of the positions of feature points (for example, a distance to a reference position relative to the screen 113).

Thereafter, the position estimator 1216 obtains, from the acceleration data acquiring module 1211, the acceleration data obtained by the acceleration sensor 16 in the second time period, and arranges the acceleration data along the time points at each of which the acceleration data has been obtained in the second time period, thus obtaining a change with time 603 in the acceleration data in the second time period. Then, according to the amplitude of the curve 602 and the gap amount of the change with time 502 in the acceleration data relative to the changes with time 601 in the positions of feature points that have been obtained by the comparison (fitting) of data in the first time period, the position estimator 1216 corrects the change with time 603 in the acceleration data in the second time period, and estimates (deems) the corrected change with time in the acceleration data in the second time period as changes with time 604 in positions of feature points in the second time period. That is, the position estimator 1216 estimates, from the change with time 603 in the acceleration data in the second time period, the changes with time 604 in the positions of a plurality of feature points in the second time period in which the positions of a plurality of feature points have not been detected from the second image data by the facial feature point detector 1212 while the acceleration data has been obtained by the acceleration sensor 16.

Referring back to FIG. 4, based on the estimated changes with time 604 in the positions of feature points in the second time period, the position estimator 1216 estimates positions of a plurality of feature points in a time period (hereinafter referred to as third time period) after the second time period (S406). In the present embodiment, as illustrated in FIG. 6, the position estimator 1216 estimates positions of a plurality of feature points 605 in the third time period by extrapolating the positions of a plurality of feature points in the third time period based on the estimated changes with time 604 in the positions of feature points in the second time period. That is, the position estimator 1216 estimates the positions of a plurality of feature points 605 in the third time period in which the acceleration data is not obtained by the acceleration sensor 16 and the positions of a plurality of feature points are not detected from the second image data by the facial feature point detector 1212.

Next, the display position determination module 1217 determines the display position of the first image data on the screen 113 based on the positions of a plurality of feature points in the third time period estimated by the position estimator 1216 (S407). For example, if the housing B (electronic device 100) moves to the right from the front of the face of the user of the electronic device 100, the position of the image data of the face in the second image data obtained by the imaging module 23 is displaced to the left. On the other hand, if the housing B (electronic device 100) moves away from the front of the face of the user, the size of the image data of the face in the second image data obtained by the imaging module 23 is reduced. That is, a relative positional relation between the housing B (electronic device 100) and the face is known from the positions of a plurality of feature points in the second image data taken by the imaging module 23. Accordingly, in the present embodiment, the display position determination module 1217 can geometrically determine the display position of the first image data on the screen 113 by transforming the coordinates of the first image data based on the positions of a plurality of feature points in the third time period.

In the present embodiment, the display position determination module 1217 determines the display position of the first image data on the screen 113 based on the positions of a plurality of feature points in the third time period. However, the display position of the first image data on the screen 113 may be determined based on the positions of a plurality of feature points in the second time period. However, determining the display position of the first image data on the screen 113 based on the positions of a plurality of feature points in the second time period means that the display position determination module 1217 determines the display position of the first image data on the screen 113 based on positions of feature points before the time of displaying the image based on the first image data on the screen 113. Therefore, if the positions of feature points when the image based on the first image data is displayed on the screen 113 have moved from the positions of a plurality of feature points in the second time period, the accuracy is reduced when suppressing the change in appearance from the viewpoint in front of the screen 113.

If an acceleration represented by the acceleration data obtained by the acceleration sensor 16 exceeds a predetermined value when the first image data is displayed on the screen 113, the display position determination module 1217 does not change the display position of the first image data on the screen 113.

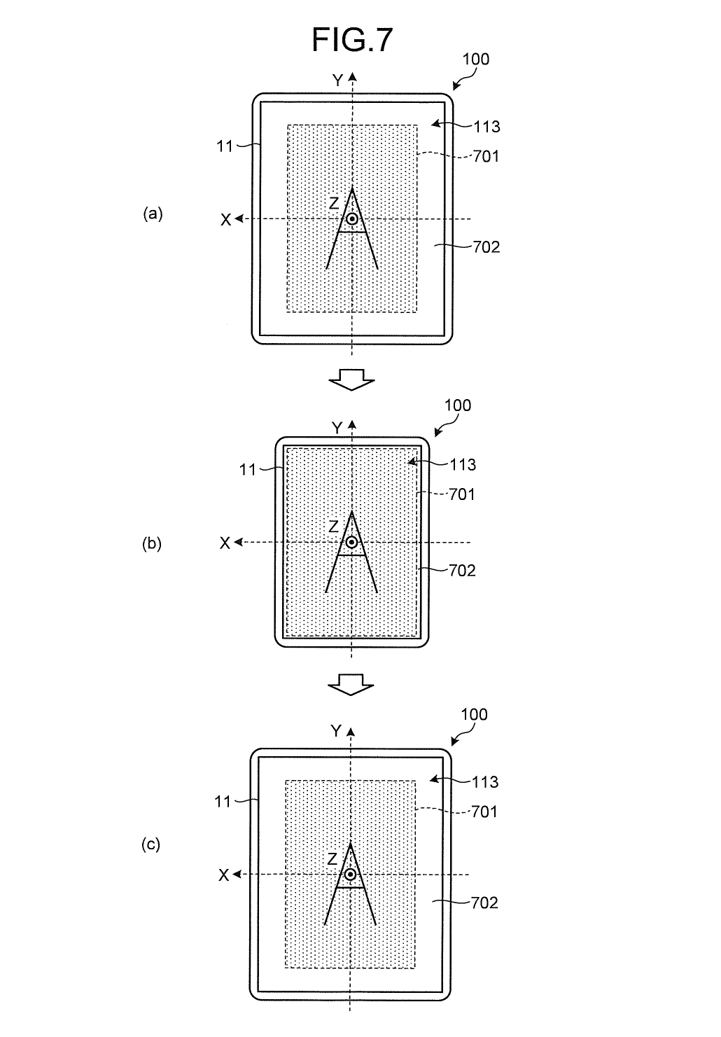

Here, using FIGS. 7 to 9, a description will be made of a process of determining the display position of the first image data on the screen 113 based on the positions of a plurality of feature points obtained from the second image data. FIGS. 7 to 9 are diagrams for explaining the process of determining the display position of the first image data on the screen in the electronic device according to the first embodiment.

First, a description will be made of the process of determining the display position by the display position determination module 1217 in the case in which the screen 113 of the electronic device 100 has moved by a distance Ad toward the far side or the near side as viewed from the user, and thus, the positions of a plurality of feature points detected from the second image data have changed. In the present embodiment, when the screen 113 is perpendicular to a direction of line of sight from at least one viewpoint in front of the screen 113 and is located at a preset distance from the viewpoint, the display position determination module 1217 determines the display position of the first image data on the screen 113 so that an image 701 (image based on the first image data) displayed on the screen 113 includes, in a peripheral portion thereof, a margin area 702, as illustrated in FIGS. 7(a), 8(a), and 9(a). When the screen 113 is perpendicular to the direction of line of sight from the at least one viewpoint in front of the screen 113 and is located at the preset distance from the viewpoint, the display position determination module 1217 may alternatively perform control so that an image displayed in the peripheral portion is displayed in a different display mode (for example, in gradation in which brightness decreases toward edges of the screen 113) from that of the image in the other area than the peripheral portion.

If the screen 113 has moved by the distance Ad toward the far side as viewed from the user, and thus, the positions of a plurality of feature points detected from the second image data have changed, the display position determination module 1217 enlarges the display position of the image 701 on the screen 113 by using a correction formula f (Δd) for enlarging the display position of the image 701 on the screen 113, and displays the image 701 in a display position including the margin area 702 of the screen 113, as illustrated in FIG. 7(b). Thereby, when the screen 113 has moved toward the far side as viewed from the user, the appearance of the image 701 from the user's viewpoint can be suppressed from decreasing in size.

If, thereafter, the screen 113 has moved by the distance Δd toward the near side as viewed from the user, and thus, the positions of a plurality of feature points detected from the second image data have changed again, the display position determination module 1217 contracts the display position of the image 701 on the screen 113 by using the correction formula f (Δd) for contracting the display position of the image 701 on the screen 113, and displays the image 701 in a display position excluding the margin area 702 of the screen 113, as illustrated in FIG. 7(c). Thereby, when the screen 113 has moved toward the far side and then moved again toward the near side as viewed from the user, the appearance of the image 701 from the user's viewpoint can be suppressed from increasing in size.

Note that the correction formula for changing the display position of the image 701 on the screen 113 is set in advance for each of the electronic device 100 because the correction formula depends on the size of the screen 113 and parameters of the imaging module 23 comprised by the electronic device 100. An arbitrary function, for example, a linear expression such as f(Δx)=aΔx+b, or a quadratic expression such as g(Δx)=Δx²+bΔx+c, is used as the correction formula for changing the display position of the image 701 on the screen 113.

Next, a description will be made of the process of determining the display position by the display position determination module 1217 in the case in which the screen 113 of the electronic device 100 has rotated by a rotation angle θ about the X-axis as an axis of rotation, and thus, the positions of a plurality of feature points detected from the image data of the face included in the second image data have changed.

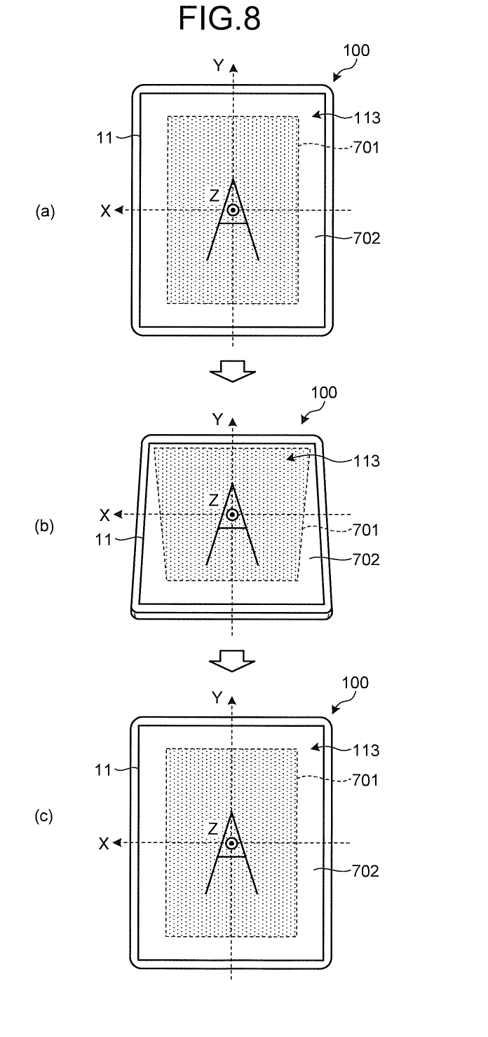

If the screen 113 has rotated by the rotation angle θ about the X-axis as an axis of rotation so that the upper portion thereof moves toward the far side as viewed from the user, the display position determination module 1217 assumes the image 701 as a three-dimensional display content, and rotates the three-dimensional display content corresponding to the rotation angle θ. Then, by rendering the rotated three-dimensional display content into a two-dimensional display content, the display position determination module 1217 enlarges the display position of the image 701 on the screen 113 as the position moves from the lower side to the upper side of the screen 113, and displays the image 701 in a display position excluding the margin area 702 of the screen 113, as illustrated in FIG. 8(b). Thereby, when the screen 113 has rotated about the X-axis as an axis of rotation so that the upper portion thereof moves toward the far side as viewed from the user, the appearance of the image 701 displayed on the upper portion of the screen 113 from the user's viewpoint can be suppressed from decreasing in size.

If, thereafter, the screen 113 has rotated by the rotation angle θ about the X-axis as an axis of rotation so that the upper portion thereof moves toward the near side as viewed from the user, the display position determination module 1217 assumes the image 701 as a three-dimensional display content, and rotates the three-dimensional display content corresponding to the rotation angle θ. Then, by rendering the rotated three-dimensional display content into a two-dimensional display content, the display position determination module 1217 contracts the display position of the image 701 on the upper portion of the screen 113, and displays the image 701 in a display position excluding the margin area 702 of the screen 113, as illustrated in FIG. 8(c). Thereby, when the screen 113 has rotated about the X-axis as an axis of rotation so that the upper portion thereof moves toward the far side and then rotated again so that the upper portion moves toward the near side as viewed from the user, the appearance of the image 701 displayed on the upper portion of the screen 113 from the user's viewpoint can be suppressed from increasing in size.

Next, a description will be made of the process of determining the display position in the display position determination module 1217 in the case in which the screen 113 of the electronic device 100 has moved in parallel with the screen 113, and thus, the positions of a plurality of feature points detected from the image data of the face included in the second image data have changed.

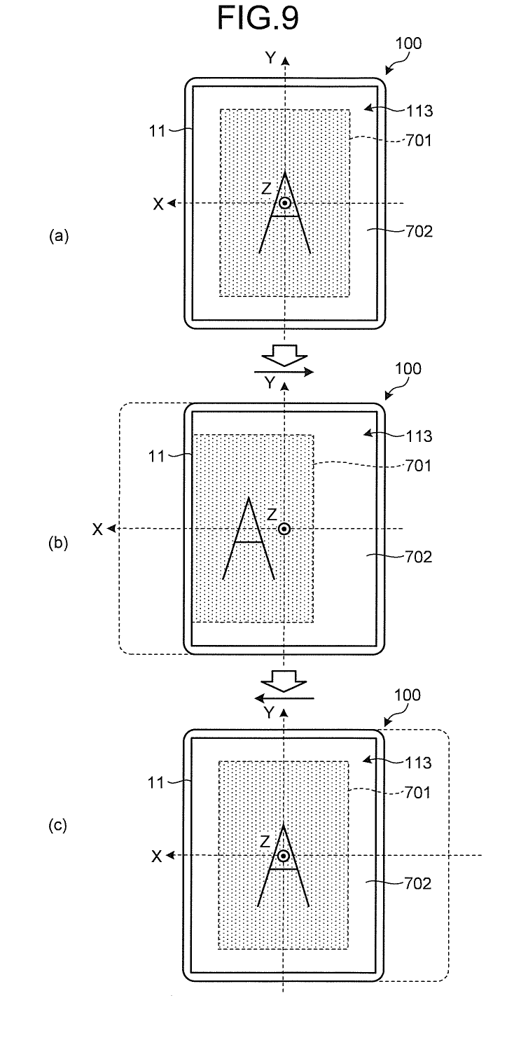

If the screen 113 has moved to the right as viewed from the user, the display position determination module 1217 moves the display position of the image 701 on the screen 113 to the left by using correction formulae g (Δx) and h (Δy) for moving the display position of the image 701 on the screen 113 to the left, and displays the image 701 in the left side margin area 702 as well of the screen 113, as illustrated in FIG. 9(b). Thereby, when the screen 113 has moved to the right as viewed from the user, the display position of the image 701 from the user's viewpoint can be suppressed from moving along with the rightward parallel movement of the screen 113.

If, thereafter, the screen 113 has moved to the left as viewed from the user, the display position determination module 1217 moves the display position of the image 701 on the screen 113 to the right by using the correction formulae g (Δx) and h (Δy) for moving the display position of the image 701 on the screen 113 to the right, and provides the left side margin area 702 of the screen 113, as illustrated in FIG. 9(c). Thereby, when the screen 113 has moved to the right and then moved again to the left in a parallel manner as viewed from the user, the display position of the image 701 from the user's viewpoint can be suppressed from moving along with the leftward parallel movement of the screen 113.

As described above, with the electronic device 100 according to the first embodiment, when the housing B moves relative to at least one viewpoint in front of the screen 113, the image displayed on the screen 113 is changed based on the changes with time in the second image data taken by the imaging module 23 and on the change with time in the acceleration data obtained by the acceleration sensor 16 so as to suppress the change in appearance of the image displayed on the screen 113 (how the image looks) as viewed from the viewpoint. Thereby, when the relative positional relation between the user's viewpoint and the screen 113 changes due to vibration, the change in the relative positional relation can be followed by the process of suppressing the change in appearance of the image displayed on the screen 113 as viewed from the viewpoint. Therefore, even when the relative position between the electronic device 100 and the face of the user changes at short periods, an image with little change in appearance can be displayed.

### Second Embodiment

A second embodiment is an example in which an electronic device is provided, on the back side thereof, with an imaging module for obtaining the second image data including the image data of the portion other than the face. In the following description, description of the same configurations as those of the electronic device according to the first embodiment will be omitted, and a description will be made of different configurations from those of the electronic device according to the first embodiment.

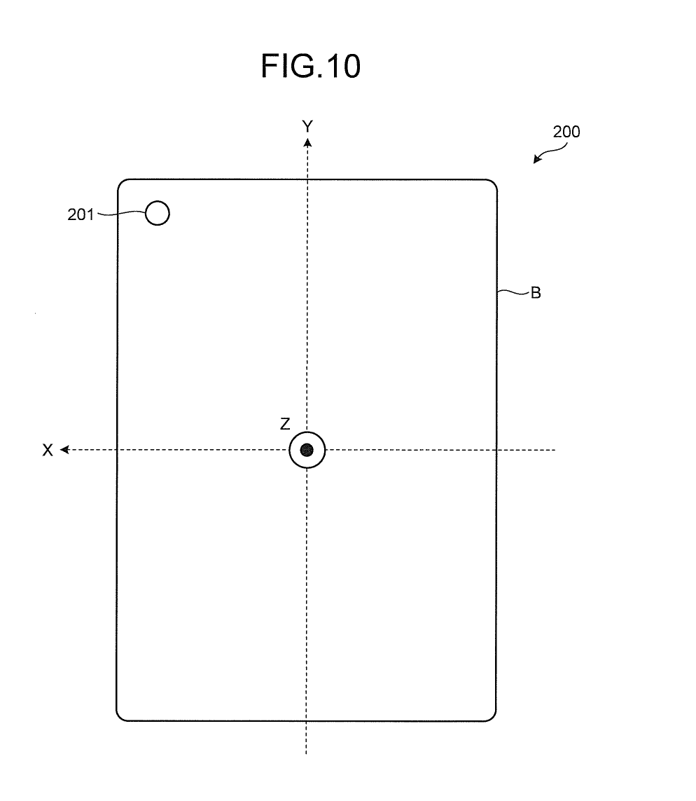

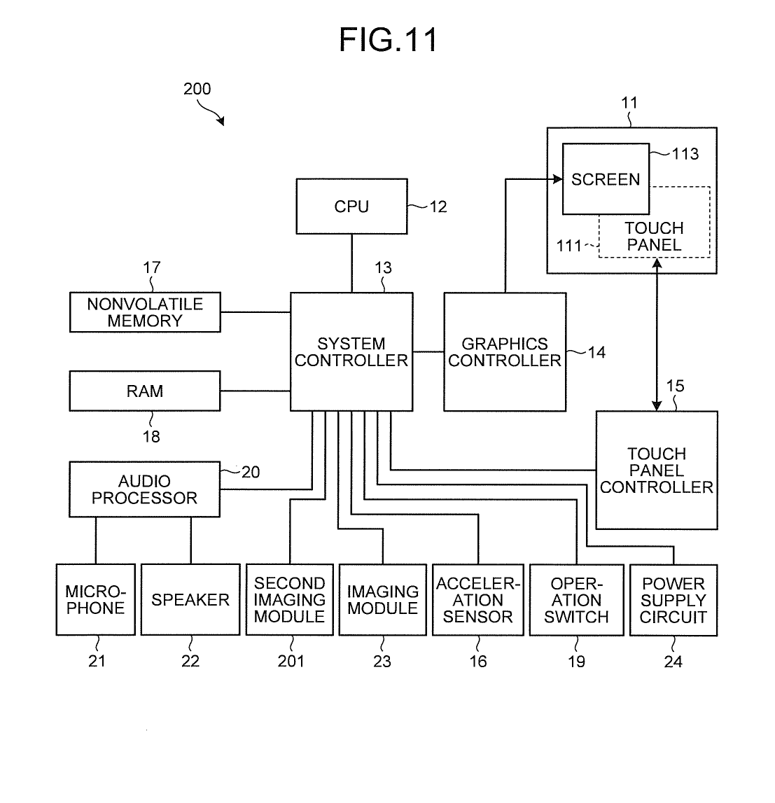

FIG. 10 is a diagram schematically illustrating an external appearance on the back side of the electronic device according to the second embodiment. FIG. 11 is a block diagram illustrating an example of a hardware configuration of the electronic device according to the second embodiment. An electronic device 200 according to the second embodiment is provided, at an upper back portion thereof, with a second imaging module 201 directed toward a direction opposite to the screen 113.

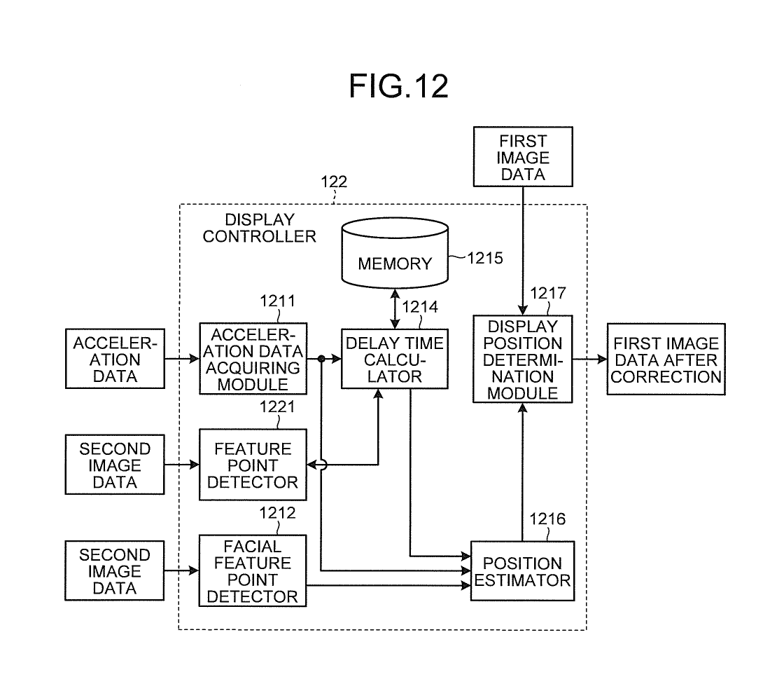

FIG. 12 is a block diagram illustrating a functional configuration of the electronic device according to the second embodiment. As illustrated in FIG. 12, the electronic device 200 according to the second embodiment comprises a display controller 122 as a functional module in cooperation with the CPU 12, the system controller 13, the graphics controller 14, and the software (operating system).

The display controller 122 according to the present embodiment comprises the acceleration data acquiring module 1211, the facial feature point detector 1212, a feature point detector 1221, the delay time calculator 1214, the memory 1215, the position estimator 1216, and the display position determination module 1217.

The feature point detector 1221 detects positions of a plurality of feature points included in second image data taken by the second imaging module 201. The method for detecting the positions of a plurality of feature points from the second image data taken by the second imaging module 201 is the same as that of the feature point detector 1213 according to the first embodiment.

In the present embodiment, the feature point detector 1221 detects the positions of a plurality of feature points included in the second image data taken by the second imaging module 201. However, the feature point detector is not limited to this. For example, the feature point detector 1221 may first detect the positions of feature points from the image data of the portion other than the face included in the second image data taken by the imaging module 23, and, if a predetermined number of positions of feature points are not detected, may detect the positions of a plurality of feature points included in the second image data taken by the second imaging module 201. Alternatively, the feature point detector 1221 may detect the positions of a plurality of feature points included in the second image data taken by the second imaging module 201, and, if a predetermined number of positions of feature points are not detected, may detect the positions of feature points from the image data of the portion other than the face included in the second image data taken by the imaging module 23. Otherwise, the feature point detector 1221 may detect the positions of a plurality of feature points from the image data of the portion other than the face included in the second image data taken by the imaging module 23 and from the second image data taken by the second imaging module 201.

In addition, the feature point detector 1221 may detect, via the power supply circuit 24, a remaining amount of electrical energy stored in a battery (not illustrated) provided in the electronic device 200. Then, if the detected remaining amount is smaller than a predetermined electrical energy, the feature point detector 1221 may shut off the supply of power to the second imaging module 201 to turn off the second imaging module 201, and may detect the positions of feature points from the image data of the portion other than the face included in the second image data taken by the imaging module 23.

As described above, with the electronic device 200 according to the second embodiment, the housing B is provided, on the back side thereof, with the second imaging module 201, and the feature point detector 1221 detects the positions of a plurality of feature points included in the second image data taken by the second imaging module 201. Thereby, for example, when the user of the electronic device 200 is walking, the second image data including image data of a road surface and surroundings is obtained. Thus, the positions of a plurality of feature points can be detected from the second image data taken by the second imaging module 201 without relying on the detection result of the positions of a plurality feature points from the image data of the face detected by the facial feature point detector 1212.

As described above, according to the first and the second embodiments, even when the relative positional relation between the electronic device and the face of the user changes at short periods, an image with little change in appearance can be displayed.

The program to be executed in the electronic device 100 or 200 of one of the present embodiments is provided by being preinstalled in a ROM or the like. The program to be executed in the electronic device 100 or 200 of the present embodiment may be configured to be provided by being recorded in a computer-readable recording medium, such as a CD-ROM, a flexible disk (FD), a CD-R, or a digital versatile disc (DVD), as files in an installable or an executable format.

The program to be executed in the electronic device 100 or 200 of one of the present embodiments may alternatively be configured to be provided by being stored on a computer connected to a network such as the Internet and by being downloaded via the network. The program to be executed in the electronic device 100 or 200 of one of the present embodiments may also be configured to be provided or distributed via a network such as the Internet.

The program to be executed in the electronic device 100 or 200 of one of the present embodiments is configured as modules including the functional modules described above, and the CPU (processor), as actual hardware, reads out the program from the above-mentioned ROM and executes the program, whereby each of the functional modules is loaded into the main memory and generated in the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a housing;
a display device in the housing, the display device comprising a screen;
an imaging module in the housing, the imaging module being configured to take an image in front of the screen;
an acceleration sensor in the housing; and
a display controller configured to control the display device to display an image based on first image data on the screen, and configured to change the image displayed on the screen based on a change with time in second image data taken by the imaging module and a change with time in acceleration data obtained by the acceleration sensor to suppress, when the housing moves relative to at least one viewpoint in front of the screen, a change in appearance of the image displayed on the screen as viewed from the viewpoint.

2. The electronic device of claim 1, wherein the display controller is configured to obtain positions of a plurality of feature points from the second image data to determine a display position of the first image data on the screen based on the positions of the feature points.

3. The electronic device of claim 2, wherein the display controller is configured to estimate, from a change with time in the acceleration data and a changes with time in the position of the feature point in a first time period, a change with time in the position of the feature point in a second time period after the first time period according to a change with time in the acceleration data in the second time period.

4. The electronic device of claim 3, wherein the display controller is configured to obtain a delay time of the second image data relative to the acceleration data from the change with time in the position of the feature point and the change with time in the acceleration data to estimate, based on the delay time, the change with time in the position of the feature point in the second time period according to the change with time in the acceleration data in the second time period.

5. The electronic device of claim 4, wherein the display controller is configured to estimate position of the feature point in a time period after the second time period based on the estimated change with time in the position of the feature point in the second time period to determine the display position of the first image data on the screen based on the estimated position of the feature point.

6. The electronic device of claim 1, wherein the display controller is configured to control the display device to display an image and a margin area in a peripheral portion of the image on the screen.

7. The electronic device of claim 1, wherein the display controller is configured to change the image displayed on the screen based on a change with time in second image data including image data of a face taken by the imaging module and the change with time in acceleration data obtained by the acceleration sensor to suppress, when the housing moves relative to the at least one viewpoint in front of the screen, the change in appearance of the image displayed on the screen as viewed from the viewpoint.

8. An electronic device comprising:
a housing;
a display device in the housing, the display device comprising a screen;
an imaging module in the housing, the imaging module being configured to take an image in front of the screen;
an acceleration sensor in the housing; and
a display controller configured to control the display device to display an image based on first image data on the screen, and configured to change the image displayed on the screen based on a change with time in second image data including image data of a face taken by the imaging module and a change with time in acceleration data obtained by the acceleration sensor to suppress, when the housing moves relative to at least one viewpoint in front of the screen, a change in appearance of the image displayed on the screen as viewed from the viewpoint.

9. A display control method performed by an electronic device comprising: a housing; a display device in the housing, the display device comprising a screen; an imaging module in the housing, the imaging module being configured to take an image in front of the screen; and an acceleration sensor in the housing, the display control method comprising:
controlling the display device to display an image based on first image data on the screen; and
changing the image displayed on the screen based on a change with time in second image data taken by the imaging module and a change with time in acceleration data obtained by the acceleration sensor to suppress, when the housing moves relative to at least one viewpoint in front of the screen, a change in appearance of the image displayed on the screen as viewed from the viewpoint.
